(19) United States
(12) Patent Application Publication
(10) Pub. No.: US 2005/0188817 A1
(43) Pub. Date: Sep. 1, 2005

(54) Detachabaly connected tensioning apparatus

(76) Inventor: Joel Thomas Whittington, Dorchester, MA (US)

Correspondence Address: Joel Whittington, Apt. 410, 35 Harbor Point Blvd., Dorchester, MA, 02125, US

(21) Appl. No.: 11/057,792

(22) Filed: Feb. 14, 2005

Related U.S. Application Data
(60) Provisional application No. 60/545,041, filed on Feb. 17, 2004.

(51) Int. Cl. G10D 13/02

(52) U.S. Cl. 84/413

(57) ABSTRACT

A detachably connected drum tensioning apparatus for quickly and easily changing a drumhead (19) includes a main body (16) for holding a common drum lug nut (14), a release arm (12) pivotally connected to the main body (16), a connecting arm (8) pivotally connected to the release arm (12), and an anchor post which communicates with the connecting arm (8) is rigidly fixed to a drum shell.

### CROSS-REFERENCE TO RELATED APPLICATIONS

This application claims the benefit of PPA Ser. No. 60/545,041, filed 2004 Feb. 17 by present inventor.

### BACKGROUND OF THE INVENTION

1. Field of Invention

This invention relates to drum head tensioning devices specifically to such tensioning devices that are removable.

2. Prior Art

The modern musical drum consists of a drum shell, head, rim, lug casings, lug nuts, and tensioning rods. Various numbers of lug casings are spaced and connected equidistance around the circumference of the cylindrical shape of the drum shell. The lug casings hold the lug nuts which receive the tensioning rods. The rim has holes made equidistance around its circumference to coincide with the number of lugs for a particular size drum. Tension rods are placed through these holes to connect with the lug nuts. A drumhead is stretched over the drum shell by the rim when the tension rods are tightened. The tension of the drumhead is adjusted by the turning of the tension rods into the lug nuts which pulls down on the rim stretching the head over the edge of the drum shell. If a person wants to change a drumhead he or she must remove a plurality of tensioning rods. Removing the tension rods takes a considerable amount of time.

There have been several patents given for inventions which attempt to reduce the amount of time it takes for the changing of drum heads: U.S. Pat. No. 4,583,442 Apr. 22, 1986 Minor, U.S. Pat. No. 4,693,163 Sep. 15, 1987 Hsieham, U.S. Pat. No. 6,492,583 Dec. 10, 2002 Wilkey. Minors invention requires a special drumhead, marketed by REMO®, known as a PTS™ head. Also, Minors invention requires the loosening of the tensioning rods. Hsiehams invention is similar to Minors but it uses a conventional drum head and rim. Hsiehams invention not only requires the loosening of the tensioning rods but removal of them in order to remove the drum rim to replace the drum head. Wilkey's invention requires the loosening of the tension rods when used with his special rim included in his U.S. Pat. No. 6,492,583 Dec. 10, 2002 Wilkey. Removal of the tension rods are required for Wilkey's invention to change the drum head if a conventional drum rim is used.

### OBJECTS AND ADVANTAGES

Accordingly several objects and advantages of the present invention are:
(a) to allow for the quick change of a musical drumhead without the loosening or removal of drum lug nuts.
(b) to reduce the amount of time it takes to tune a replaced drum head to the tension of the original drumhead.

### SUMMARY

In accordance with the present invention a detachably connected tensioning apparatus includes a common drum lug nut, main body, an anchor post means, lever means for engaging and disengaging the apparatus, connecting arm means, and any pivotally connectable fasteners.

### DRAWINGS—FIGURES

FIG. 1 is an isometric view of a detachably connected drum tensioning apparatus connected to a rim of a drum and detached from a base post.

FIG. 2 Shows exploded view of a detachably connected tension apparatus and an anchor post.

FIG. 3 is a back schematic view of a detachably connected tensioning apparatus in locked position on an anchor post and side schematic view of base post with attaching bolt.

### DRAWING—REFERENCE NUMERALS

| | |
|---|---|
| 6-Fastner | 16-Main body |
| 8-Connecting arm | 17-Rim |
| 10-Spacer | 18-Anchor post |
| 11-Drum head | 19-Drum shell |
| 12-Release arm | 20-Pliable spacer |
| 14-Lug nut | 22-Connector bolt |
| 15-Tension rod | |

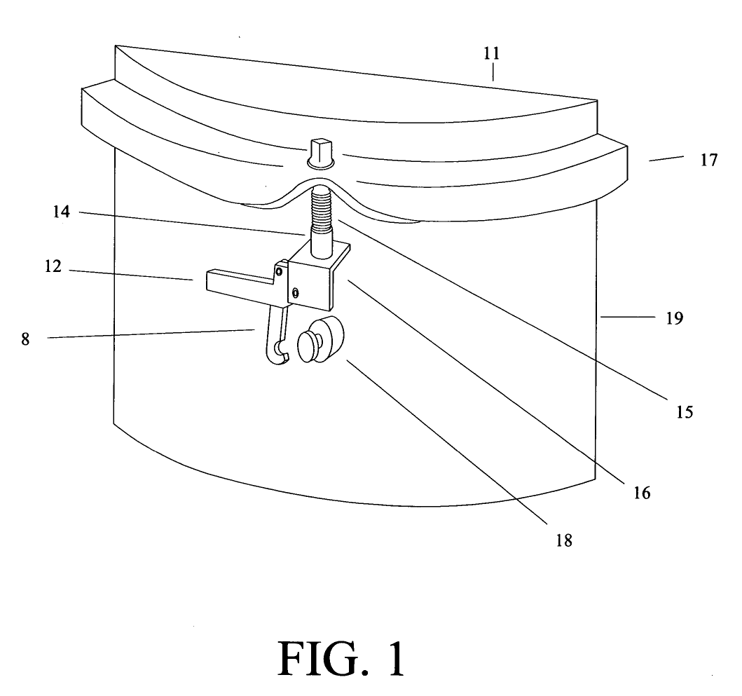

### DETAILED DESCRIPTION—PREFERRED EMBODIMENT—FIGS. 1-3

FIG. 1 provides an isometric view of a detachably connected tensioning apparatus in disconnecting operation from anchor post 18 while being connected to a drum rim 17. The tension rod 15 is connected to a main body 16 of the tensioning apparatus by a lug nut 14. A release arm 12 is in release position to allow a connecting arm 8 to disconnect from an anchor post 18. The anchor post 18 is rigidly connected to a drum shell 19.

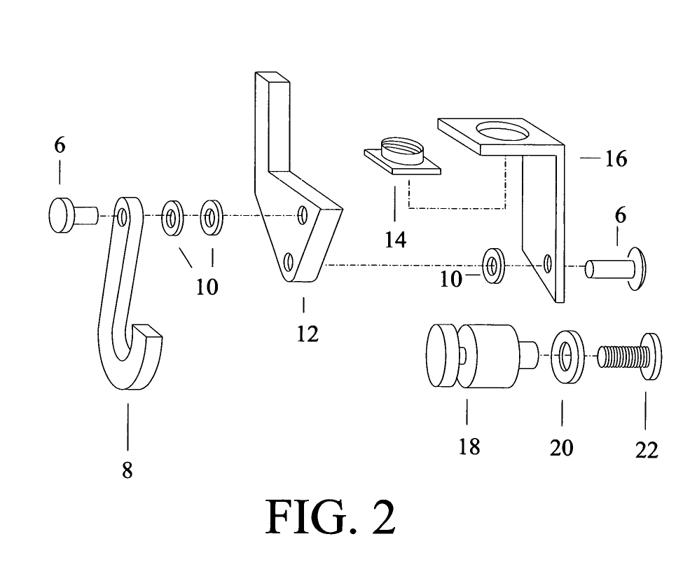

FIG. 2 provides an exploded view of the said apparatus and the corresponding anchor post 18. A fastener 6 connects the connecting arm 8 pivotally with release arm 12 spaced with spacers 10. The release arm 12 is then connected pivotally to the main body 16 with fastener 6 and space provided between them with a spacer 10. The lug nut 14 is placed through an opening from the underside of the flange of the main body 16.

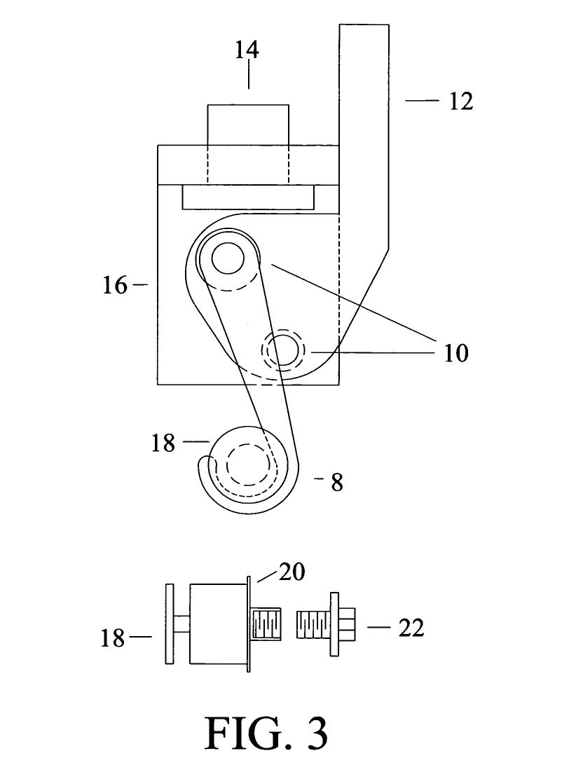

FIG. 3 provides back schematic view of said apparatus with all parts assembled and in locked position with anchor post 18. FIG. 3 also shows side schematic view of anchor post 18 with pliable washer 20 and connector bolt 22 dislodged.

Operation:

When one wants to remove a drum head 11 using the detachably connected tensioning apparatus of FIG. 1 he or she needs to pull the release arm 12 to detach the connecting arm 8 from the anchor post 18. The rim 17 can then be removed. This will allow head 11 to be replaced. After the head 11 is replaced, the rim 17 is replaced. Next the connector arm 8 is secured to anchor post 18 when the release arm 12 is pulled up to the locked position. This allows the drumhead 11 to become taught for playing.

### CONCLUSION, RAMIFICATIONS, AND SCOPE

Thus the reader will see that the detachably connected tensioning apparatus provides ease of use and saves time when changing a drumhead.

While my above description contains many specificities these should not be construed as limitations on the scope of the invention, but rather as an exemplification of one preferred embodiment thereof. Many other variations are possible such as a decorative main body. Also all parts of the invention could be made from any material that would possess the tensile strength required for high-tension applications. The sizes of the parts of the invention could also be changed in order to accommodate different sized drums.

1. A detachable drum tensioning lug comprising:
(a) a main body adapted to hold a common drum lug nut,
(b) a release arm means pivotally connected to said main body,
(c) a connection arm means pivotally connected to said leaver engagement means and
(d) an anchor post means adapted to be mounted to a drum shell, the anchor means having a furrow around its perimeter for receiving said connection arm means.
